(19) United States
(12) Patent Application Publication
(10) Pub. No.: US 2014/0217751 A1
(43) Pub. Date: Aug. 7, 2014

(54) LATCH MECHANISM

(71) Applicants: Francisco Javier Lujan, Cuidad Juarez (MX); Fernando Chacon Ramos, Cuidad Juarez (MX); Donald Michael Perkins, Sterling Heights, MI (US); Kurt E. Nurmi, Macomb, MI (US)

(72) Inventors: Francisco Javier Lujan, Cuidad Juarez (MX); Fernando Chacon Ramos, Cuidad Juarez (MX); Donald Michael Perkins, Sterling Heights, MI (US); Kurt E. Nurmi, Macomb, MI (US)

(21) Appl. No.: 14/169,678

(22) Filed: Jan. 31, 2014

Related U.S. Application Data
(60) Provisional application No. 61/760,274, filed on Feb. 4, 2013.
(60) Provisional application No. 61/760,276, filed on Feb. 4, 2013.

(51) Int. Cl. E05B 77/38

(52) U.S. Cl. CPC E05B 77/38
USPC 292/216

(57) ABSTRACT

A latch is provided including a fork bolt configured to rotate between an unlatched position and a latched position. A detent is configured to cooperate with the fork bolt. At least one of the fork bolt and the detent includes a resilient absorption mechanism. The resilient absorption mechanism is configured to deform upon impact and decelerate the rotation of either the fork bolt of the detent respectively. The latch also includes a housing and a stop tab protruding from the housing. The stop tab is configured to engage a complementary portion of the fork bolt with in a latched position to limit further rotation thereof.

### CROSS REFERENCE TO RELATED APPLICATIONS

This application claims the benefit of U.S. Provisional Patent Application Ser. No. 61/760,274 filed Feb. 4, 2013, the contents of which are incorporated herein by reference thereto. This application also claims the benefit of U.S. Provisional Patent Application Ser. No. 61/760,276 filed Feb. 4, 2013, the contents of which are also incorporated herein by reference thereto.

### TECHNICAL FIELD

Exemplary embodiments of the present invention relate generally to latches and, more particularly, to latches for vehicles.

### BACKGROUND

Latches are used to restrain the movement of one member or element with respect to another. For example, door latches restrain the movement of a door with respect to a surrounding door flame. The function of such latches is to hold the door secure within the frame until the latch is released and the door is free to open, Existing latches typically have mechanical connections linking the latch to actuation elements such as handles which can be actuated by a. user to release the latch. Movement of the actuation elements is transferred through the mechanical connections that cause the latch to release. The mechanical connections can be one or more rods, cables, or other suitable elements or devices.

Latch sound quality can enhance or detract from the overall perception of quality by an end user about the construction of the vehicle. For example, good sound quality may imply solid construction, smooth operation, and thoughtfulness of design. As a result, vehicle manufacturers are placing more emphasis on the ability of the door latch to absorb the noise emissions that may occur during a closing event. Sound quality metrics, such as minimal loudness and frequency content for example, are affected by many variables including the profile geometry, small features, and material selection of the components of a latch mechanism.

Accordingly, while existing vehicle latch mechanisms are suitable, the need for improvement remains, particularly in providing a latch mechanism having improved noise dampening and energy absorption.

### SUMMARY OF THE INVENTION

In accordance with one embodiment, a latch is provided including a fork bolt configured to rotate between an unlatched position and a latched position. A detent is configured to cooperate with the fork bolt. At least one of the fork bolt and the detent includes a resilient absorption mechanism. The resilient absorption mechanism is configured to deform upon impact and decelerate the rotation of either the fork bolt of the detent respectively. The latch also includes a housing and a stop tab protruding from the housing. The stop tab is configured to engage a complementary portion of the fork bolt with in a latched position to limit further rotation thereof.

According to another embodiment of the present invention, a housing for a latch rotatable between an unlatched position and a latched position is provided including an opening for receiving a striker wire. The opening is complementary to a throat of the latch. The opening is sized such that when the striker wire is inserted into the opening, the striker wire does not contact the housing.

According to yet another embodiment of the present invention, a latch rotatable between an unlatched position and a latched position is provided including a resilient bumper. The bumper includes an upper contact portion arranged generally perpendicular to an elongated lower portion. The bumper is configured to receive a portion of a striker wire between the upper contact portion and the elongated lower portion to absorb noise and vibrations from the striker wire.

According to yet another embodiment of the present invention, a latch is provided including a fork bolt rotatable between an unlatched position and a latched position. A detent is configured to cooperate with the fork bolt. At least one noise-reducing component is configured to absorb noise and vibration generate by receipt of the striker wire within the latch.

The above-described and other features and advantages of the present invention will be appreciated and understood by those skilled in the art from the following detailed description, drawings, and appended claims.

### BRIEF DESCRIPTION OF THE DRAWINGS

Embodiments of the present invention will now be described, by way of example only, with reference to the accompanying drawings in which:

FIG. 1 is a front view of a latch mechanism in a primary latched position according to an embodiment of the invention;

FIG. 2 is a front view of a latch mechanism in a secondary latched position according to an embodiment of the invention;

FIG. 3 is a front view of a housing of a latch mechanism in a primary latched position according to an embodiment of the invention;

FIG. 4 is a perspective view of the housing of a latch mechanism according to an embodiment of the invention;

FIG. 5 is a perspective view of a backside of a stop tab of the latch mechanism according to an embodiment of the invention;

FIG. 6 is a front view of a stop tab of the latch mechanism according to an embodiment of the invention;

FIG. 7 is a front view of a bumper of a latch mechanism according to an embodiment of the invention; and

FIG. 8 is a front view of the bumper when the latch mechanism is a secondary latched position according to an embodiment of the invention.

### DETAILED DESCRIPTION

With reference to all of the FIGS., an exemplary latch 10 having improved sound performance is illustrated. The latch 10 is movable between a latched position and an unlatched position, and is disposed within a housing 12. The latch 10 may be integrated into a component of a vehicle, such as the vehicle structure adjacent a lift gate, trunk, door, or any other operable component for example.

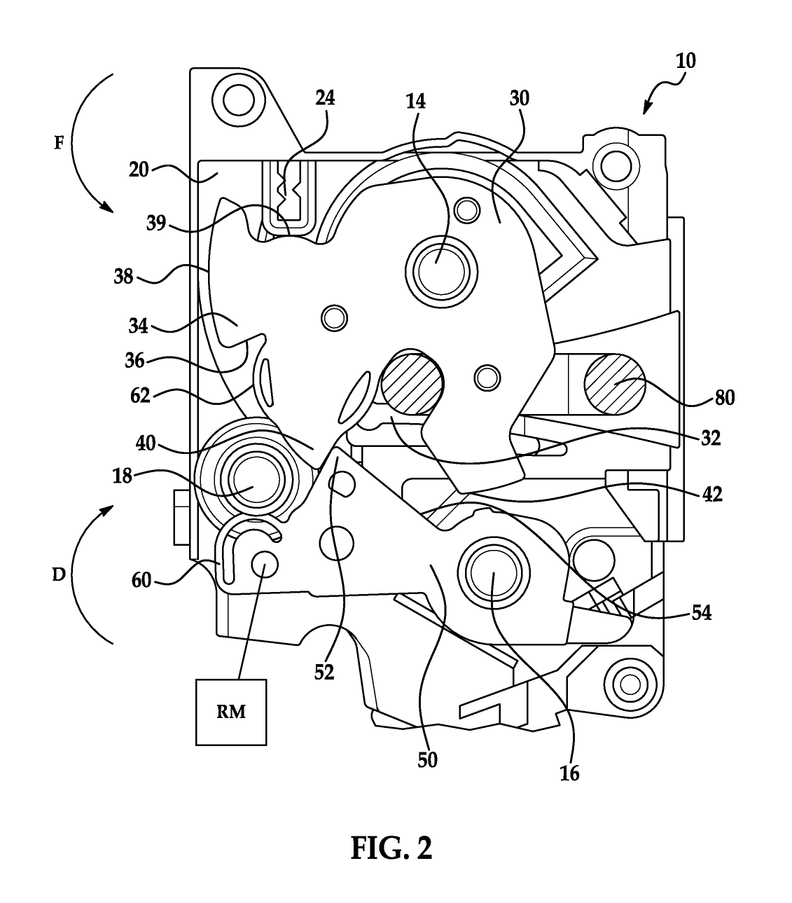

The latch 10 includes a fork bolt 30 and a cooperating detent lever 50 for maintaining the fork bolt 30 in the latched position. The fork bolt 30 and the detent lever 50 are each pivotally mounted to the housing 12 of the latch 10 by a stud (not shown) positioned in holes 14, 16 respectively. The fork bolt 30 is biased in the direction of arrow F by a first biasing mechanism (not shown), and the detent lever 50 is biased in the direction of arrow D, into engagement with the fork bolt 30, by a second biasing mechanism (not shown). In one embodiment, the first and second biasing mechanisms are coil or torsion springs. The fork bolt 30 has slot or throat 32 for receiving and retaining a striker 80 (see FIGS. 2, 4), such as a wire-loop striker for example, located on a complementary vehicle component, such as a lift gate or trunk. The fork bolt 30 also includes a primary shoulder 40 and an intermediate or secondary shoulder 34. The secondary shoulder 34 of the fork bolt 30 includes a contact surface 38 configured to contact an engagement surface 54 of the detent lever 50 when rotating between an unlatched and a latched position

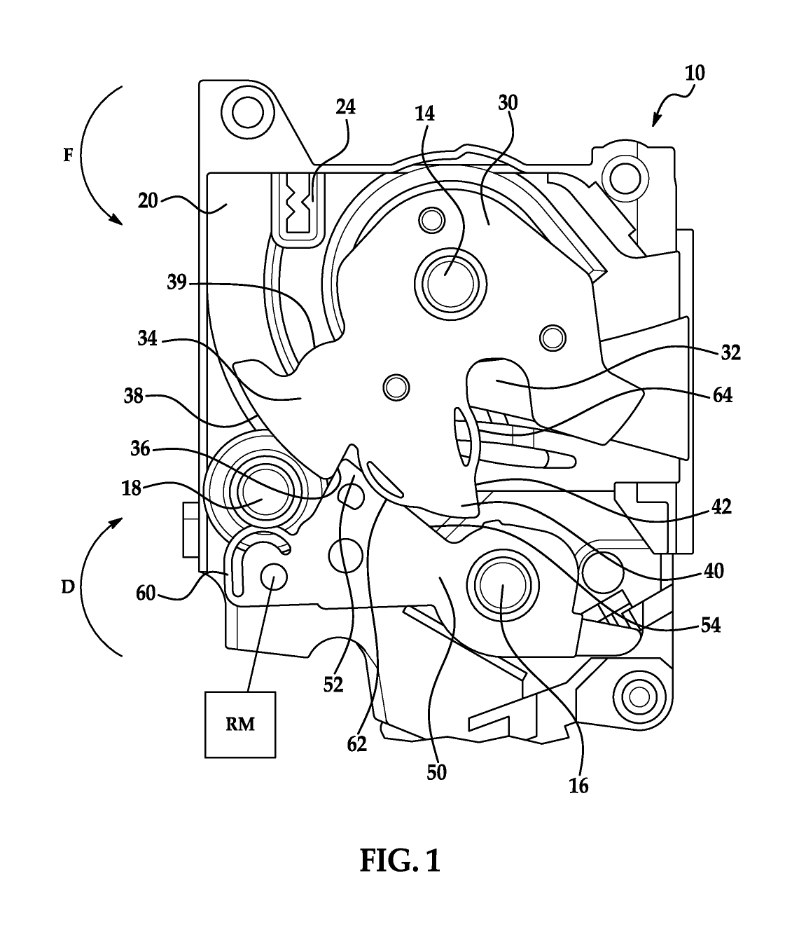

The detent lever 50 includes a sector-shaped catch 52 configured to positively engage a surface 42, 36 of each of the primary and secondary shoulders 40, 34 to hold the fork bolt 30 against the bias of the first biasing mechanism in either a primary latched position (FIG. 2) or secondary latched position (FIG. 1) respectively. In one embodiment, a portion of the detent lever 50 is coupled to a release mechanism RM, illustrated schematically in FIG. 1. The aforementioned fork bolt 30 and detent lever 50 are illustrated as a non-limiting embodiment. Numerous other types or configurations of the fork bolt 30 and detent lever 50 are considered to be within the scope of an exemplary embodiment of the present invention.

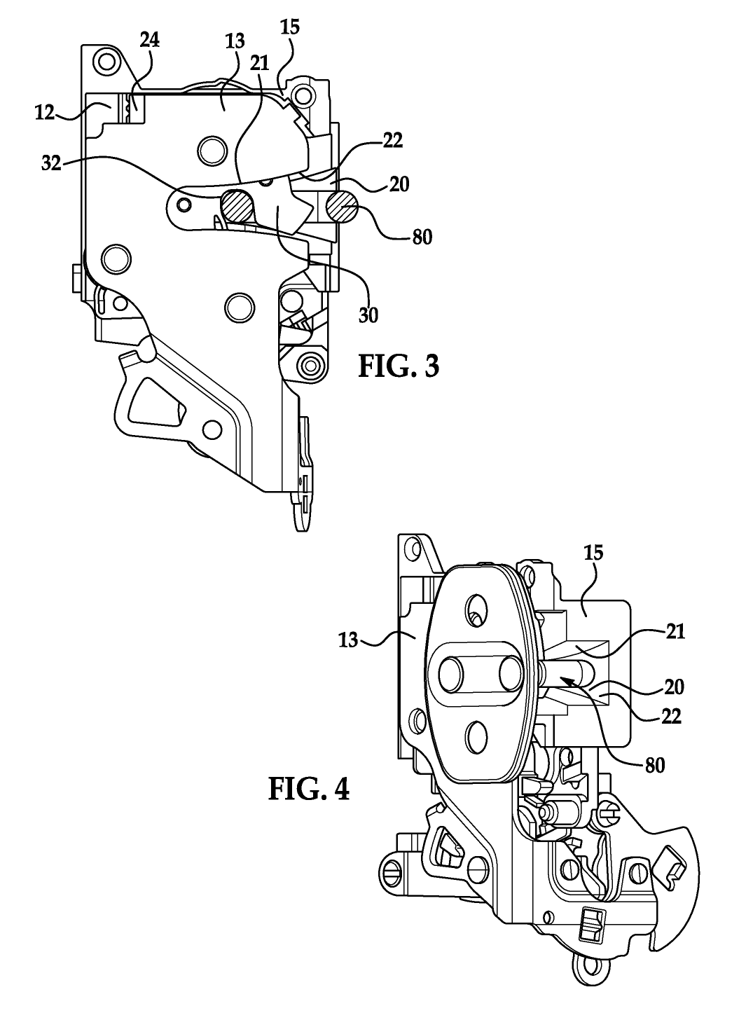

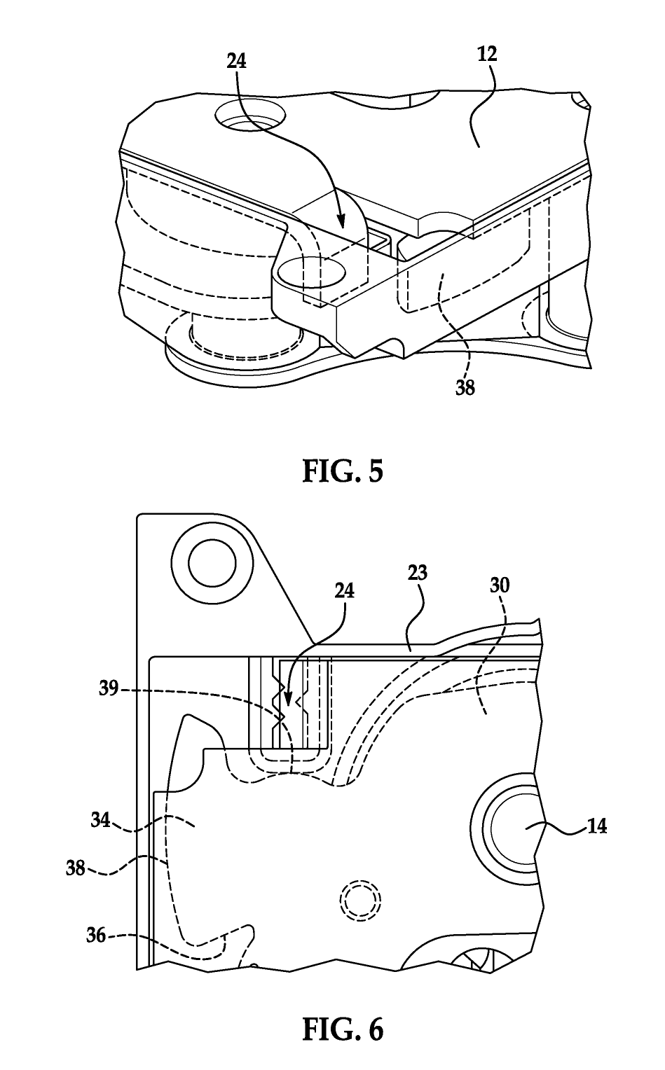

As best illustrated in FIGS. 3 and 4, the housing 12 of the latch 10 includes a cover 13 and back plate 15 between which the detent lever 50 and fork bolt 30 are sandwiched. Both the back plate 15 and the cover 13 have an opening 20 generally aligned with and complementary to the throat 32 of the fork bolt 30 when the fork bolt 30 is in an unlatched position. In one embodiment, the mouth 22 of the opening 20 is generally wider than conventional openings to prevent the striker wire 80 from contacting a portion of the opening 20, such as a sidewall 21 for example. Additionally, the housing 12 may include a stop tab 24 formed near a corner of the housing 12, for example between a wall 23 and the fork bolt 30, to prevent overtravel of the fork bolt 30 as it rotates between an unlatched position and a latched position. In one embodiment, the stop tab 24 is formed by bending a portion of cover 13, perpendicular to the plane of the cover 13 in the direction of the fork bolt 30 (FIG. 5). When the fork bolt 30 is in a primary latched position, an overtravel surface 39 of the fork bolt 30, positioned opposite the secondary shoulder 34, is configured to contact the stop tab 24. The overtravel surface 39 is complementary to the contour of the stop tab 24 such that when the fork bolt 30 engages the stop tab 24, the stop tab 24 absorbs noise and vibration created by the impact from the fork bolt 30.

Referring again to FIG. 1, the free end of the detent lever 50 includes a resilient absorption mechanism 60. In one embodiment, the absorption mechanism 60 is formed integrally with the detent lever 50 and is configured to engage a pin (not shown) positioned within a hole 18 between the detent lever 50 and the fork bolt 30. Similarly, the fork bolt 30 includes a first absorption mechanism 62 adjacent the secondary shoulder 34 and a second absorption 64 mechanism adjacent the primary shoulder 40. The first absorption mechanism 62 is configured to engage the engagement surface 54 of the detent lever 50 and the second absorption mechanism 64 is configured to engage the striker wire 80. Each of the absorption mechanisms 60, 62, 64 of the detent lever 50 and fork bolt 30 will deform upon impact with another component, and will therefore cause a deceleration of either the detent lever 50 or fork bolt 30 respectively. Once a force is removed, the absorption mechanisms 60, 62, 64, will return to a neutral un-deformed state.

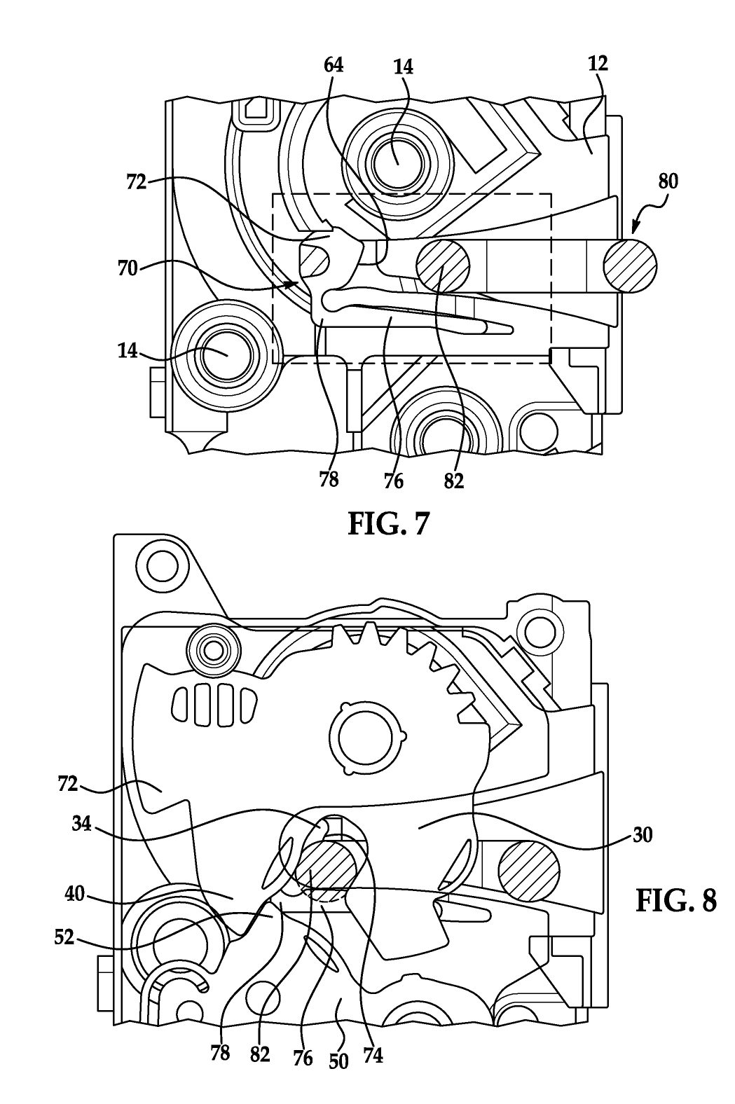

As illustrated in FIGS. 7 and 8, the latch 10 additionally includes a bumper 70 arranged between the housing 12 and the plane of the fork bolt 30 and detent lever 50. The bumper 70 is positioned near the interface between the shoulder 52 of the detent lever 50 and the shoulders 34, 40 of the fork bolt 30. The bumper 70 includes an upper contact portion 72 and an elongated lower portion 76 arranged generally perpendicularly to the upper contact portion 72. In one embodiment, the bumper 70 is made from a flexible material, such as rubber or soft plastic for example. A surface 74 of the upper contact portion 72 is angled towards the bend 78 of the bumper 70. The bumper 70 is configured to dampen sound generated by the contact between the fork bolt 30 and the striker wire 80.

When a striker wire 80 is received within the throat 32 of the fork bolt 30, the striker wire 80 engages the second absorption mechanism 64 and applies a force thereto. Receipt of the striker wire 80 causes the fork bolt 30 to pivot from an unlatched position towards a latched position, in a direction opposite the direction indicated by arrow F, such that the contact surface 38 of the secondary shoulder 34 slidably contacts the engagement surface 54 of the detent lever 50. As the fork bolt 30 pivots past the secondary latched position to the primary latched position, the portion 82 of the striker wire 80 within the throat 32 contacts the angled upper surface 74 of the bumper 70. Further rotation of the fork bolt 30 to the primary latched position (fully closed position) causes portion 82 of the striker wire 80 to wedge between the angled upper surface 74 and the elongated lower portion 76 adjacent the bend 78, as illustrated in FIG. 8. Once the fork bolt 30 reaches the primary latched position, the detent lever 50 is biased into contact with the primary shoulder 40 of the fork bolt 30, thereby preventing the fork bolt 30 from rotating towards the unlatched position until the detent lever 50 is mechanically released or disengaged. In addition, the stop tab 24 formed within the housing 12 prevents further rotation of the fork bolt 30 beyond the primary latched position. As the detent lever 50 is biased into engagement with the primary shoulder 40, the absorption mechanism 60 of the detent lever 50 contacts the adjacent pin (not shown) and deforms to slow the rotational speed of the detent lever 50.

To open the latch 10, actuation of the release mechanism RM coupled to the detent lever 50 causes the detent lever 50 to rotate out of engagement with the fork bolt 30. The biasing mechanism acting on the fork bolt 30 pivots the fork bolt 30 in the direction indicated by arrow F, towards the unlatched position. As the fork bolt 30 pivots open, the primary shoulder 40 applies a force to portion 82 of the striker wire 80. The upper contact portion 72 and the elongated lower portion 76 of the bumper 70 flex to release the striker wire 80 such that the fork bolt 30 may further rotate relative to the housing 12 to an open, unlatched position.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A latch comprising:
a forkbolt configured to rotate between an unlatched position and a latched position;
a detent configured to cooperate with the forkbolt, wherein at least one of the fork bolt of the detent includes a resilient absorption mechanism configured to deform upon impact and decelerate the rotation of either the forkbolt or detent respectively;
a housing; and
a stop tab protruding from the housing, the stop tab being configured to engage a complementary portion of the fork bolt when in a latched position, to limit further rotation thereof

2. The housing according to claim 1, wherein the stop tab is formed by bending a portion of the housing.

3. The housing according to claim 2, wherein the housing includes a cover, and the stop tab is formed by bending a portion of the cover.

4. The housing according to claim 1, wherein the stop tab is configured to engage an overtravel surface of a fork bolt positioned within the housing.

5. The latch according to claim 1, wherein the absorption mechanism is integrally formed with at least one of the fork bolt and detent.

6. The latch according to claim 1, wherein the detent includes an absorption mechanism adjacent a free end, the absorption mechanism being configured to contact a pin disposed between the fork bolt and the detent.

7. The latch according to claim 1, wherein the fork bolt includes an absorption mechanism adjacent a primary shoulder, the absorption mechanism being configured to contact a striker wire received within a throat of the fork bolt.

8. The latch according to claim 1, wherein the fork bolt includes an absorption mechanism adjacent a secondary shoulder, the absorption mechanism being configured to contact an adjacent surface of the detent.

9. A housing for a latch rotatable between an unlatched and a latched position comprising:
an opening for receiving a striker wire, complementary to a throat of the latch, wherein the opening is sized such that when the striker wire is inserted into the opening, the striker wire does not contact the housing.

10. A latch rotatable between an unlatched position and a latched position comprising:
a resilient bumper including an upper contact portion arranged generally perpendicularly to an elongated lower portion, the bumper being configured to receive a portion of a striker wire between the upper contact portion and the elongated lower portion to absorb noise and vibrations from the striker wire.

11. The latch according to claim 10, wherein the bumper is made from a flexible material.

12. The latch according to claim 10, wherein rotation of the latch ushers a portion of the striker wire into engagement with the bumper.

13. The latch according to claim 10, wherein the upper contact portion includes an angled contact surface configured to guide the striker between the upper contact portion and the lower portion.

14. A latch comprising:
a fork bolt rotatable between an unlatched and a latched position;
a detent configured to cooperate with the fork bolt; and
at least one noise-reducing component configured to absorb noise and vibration generated by receipt of a striker wire within the latch.
